(19) United States
(12) Patent Application Publication
(10) Pub. No.: US 2004/0102102 A1
(43) Pub. Date: May 27, 2004

(54) Electrical socket

(76) Inventors: Gerhard Schwarz, Schoenbrunn-Allemuehl (DE); Rainer Naumann, Mannheim (DE)

Correspondence Address: FISH & RICHARDSON P.C., 1425 K STREET, N.W., 11TH FLOOR, WASHINGTON, DC, 20005-3500, US

(21) Appl. No.: 10/450,959

(22) PCT Filed: Dec. 18, 2001
(86) PCT No.: PCT/EP01/14923

(30) Foreign Application Priority Data
Dec. 18, 2000 (DE) 200 21 374.1

(51) Int. Cl. H01R 13/10

(52) U.S. Cl. 439/682

(57) ABSTRACT

An electrical socket, in particular for explosion-proof areas, comprising a socket insert, which is supported in a socket housing such that it is adapted to be rotated between off- and on-positions and in which a substantially pin-shaped locking means is supported such that it is displaceable between a pressed-down blocking position and a release position in which it projects beyond the socket insert. In the release position of the locking means, said socket insert is rotatable between said off- and on-positions.

In order to improve an electrical socket of this type in such a way that it can also be connected to other plugs on certain occasions, the substantially pin-shaped locking means is defined by at least one removable locking component and a blocking component, which are arranged on top of one another in the socket insert, the locking component projecting beyond the socket insert in the release position.

The present invention relates to an electrical socket, in particular for explosion-proof areas, comprising a socket insert, which is supported in a socket housing such that it is adapted to be rotated between off- and on-positions and in which a substantially pin-shaped locking means is supported such that it is displaceable between a pressed-down blocking position and a release position in which it projects beyond the socket insert, said socket insert being rotatable between said off- and on-positions in the release position of the locking means.

An electrical socket of this type is known from DE 299 15 263. The known socket constitutes part of an electrical plug and socket device, wherein a socket insert of the socket is adapted to be rotated between off- an on-positions by means of the plug inserted in said socket. The substantially pin-shaped locking means is provided with at least one coding projection which, in the condition in which the plug is inserted in the socket insert, is arranged in a complementary coding aperture in the plug thus arranging the locking means in its release position. In the release position of the locking means, the socket insert is rotatable between the off- and on-positions.

Such electrical plug and socket devices permit voltage-free plugging and switching on, in particular for explosion-proof areas. Due to suitable coding of the pin-shaped locking means and of the plug having a complementary coding aperture, the electrical plug and socket device can only be switched on when a specific plug is used. If a plug has a different coding aperture or no coding aperture at all, the locking means will be pressed down to its blocking position and it will be impossible to rotate the socket insert from the off-position to the on-position. Without the use of a suitable plug, the locking means is arranged in its release position because it is acted upon by a spring or the like.

The known electrical socket can therefore only be connected to the associated plug and it cannot be used with other plugs.

It is the object of the present invention, to improve an electrical socket of the type mentioned at the beginning in such away that the electrical socket can also be connected to other plugs on certain occasions.

In connection with the features of the generic clause of claim 1, this object is achieved in that the substantially pin-shaped locking means is defined by at least one removable locking component and a blocking component, which are arranged on top of one another in the socket insert, the locking component projecting beyond the socket insert in the release position.

In the inserted condition of the locking component, the electrical socket according to the present invention can, in the usual way, only be connected to a suitably coded plug. If the locking component is, however, removed, only the blocking component of the locking means is still arranged in the socket insert. Said blocking component does not project beyond the socket insert so that a suitable code in a plug connectable to the socket will not be necessary in this case. This means that also a commercially available industrial plug can then be inserted completely in the electrical socket so that said electrical socket can be rotated from its off-position to its on-position. The locking component can be removed especially in cases in which the device in question, to which the electrical socket is connected, has power supplied thereto for the purpose of repair or the like and especially in an area which is not explosion-prone. For such repair purposes a special plug code is not necessary and, in particular, it is not necessary to stock up with suitably coded plugs for different codes and to use these plugs for connection with the electrical socket. Instead, any electrical socket can be used, independently of the code of its locking means, in combination with a commercially available industrial plug especially for the purpose of repair.

Since the electrical socket according to the present invention is essentially coded through the locking component, it is imaginable that the locking component and the blocking component have different cross-sections. Only the locking component is arranged such that a respective coding projection thereof is located in an associated coding aperture in the plug. It is, for example, imaginable that the blocking component has a circular cross-section, whereas the locking component has a cross-section which is used for the purpose of coding. Such a cross-section is e.g. a specific angular cross-section, an irregularly shaped cross-section, a cross-section having two arms which extend away from a centre, a star-shaped cross-section, or the like. It is, of course, also possible that the arms of the above-mentioned cross-section are arranged at an angle other than 180° or that more than two arms project from the respective centre.

In order to prevent the locking component from falling out of the socket insert, it is also possible to releasably secure the locking component in said socket insert. In this way, the locking component cannot fall out and get lost, when the plug has been removed. In addition, it will in this case not be necessary to reinsert the locking component prior to each insertion of a plug, but the locking component will remain in the socket insert also after the removal of the plug.

Releasable fastening of the locking component can be executed in different ways. According to a simple embodiment, the locking component can be provided with a lateral longitudinal slot which is adapted to be engaged with a locking pin that is displaceably supported in the socket insert. Other possibilities of releasably fastening the locking component are a suitable locking engagement between the locking component and the socket insert and/or the blocking component or the like. Also the locking pin can be spring-loaded towards the position of engagement so that it will automatically engage the respective longitudinal slot in the inserted condition of the locking component. The locking pin can be released e.g. by means of a tool or by means of a separate device provided on the socket.

In order to make it more difficult to remove the locking component and in order to permit such removal only with a suitable authorization, the locking pin can be adapted to be locked by a closing cylinder arranged in the socket insert. For operating the closing cylinder a suitable key is necessary. By means of this key, the closing cylinder can be rotated between an open position and a closed position, just as in the case of a known lock. In the closed position, the locking pin is in engagement with the longitudinal slot in the locking component so that said locking component cannot be removed from the socket insert. In the open position of the closing cylinder, the locking pin does not engage the longitudinal slot and the locking component can be removed easily.

In order to indicate, in the removed condition of the locking component, to every user of the electrical socket that said electrical socket should no longer be used, especially not in explosion-prone areas, a warning can be visible when the locking component has been removed. A simple embodiment of such a warning is a specific marking of the end of the blocking component facing the locking component, said marking being visible when the locking component has been removed. Said end can be marked e.g. by a suitable warning colour.

In order to make the warning more clearly perceptible, it can be visible on an electrically operated display means. Such a display means is, in the simplest case, a warning lamp which lights up when the locking component has been removed. Such a warning lamp may e.g. light up red when the locking component has been removed. It is also possible that, in the inserted condition of the locking component, an additional lamp lights up green so as to permit the use of the electrical socket according to the present invention in particular in explosion-prone areas.

The display means can also be designed such that a readable warning is displayed, such as “do not use in explosion-prone areas”:

The presence or absence of the locking component can be detected electrically; according to a simple embodiment, an electric contact can be closed and the electric display can be switched ineffective, when the locking component and the blocking component abut on one another. Separate electrical means in the socket insert can be dispensed with in this way, and the electric display means is switched on or off directly via the locking component and the blocking component.

In order to establish the electric contact between the locking component and the blocking component in a simple manner, the locking component may have a contact element on its end facing the blocking component, said contact element interconnecting electric lines provided in or on the blocking component. When, in the inserted condition of the locking component, said electric lines are interconnected, the electric display means is switched ineffective and does not display any warning. When the locking component has been removed, the electric display means is switched effective.

In accordance with a simple embodiment, the contact element can be implemented as a short-circuit contact which shorts two electric lines conducted through the blocking component to the display means. The electric lines are, in this way, short-circuited in the inserted condition of the locking component and the display means is not supplied with power.

In the following, an advantageous embodiment of the present invention will be explained in detail on the basis of the figures added in the drawing, in which:

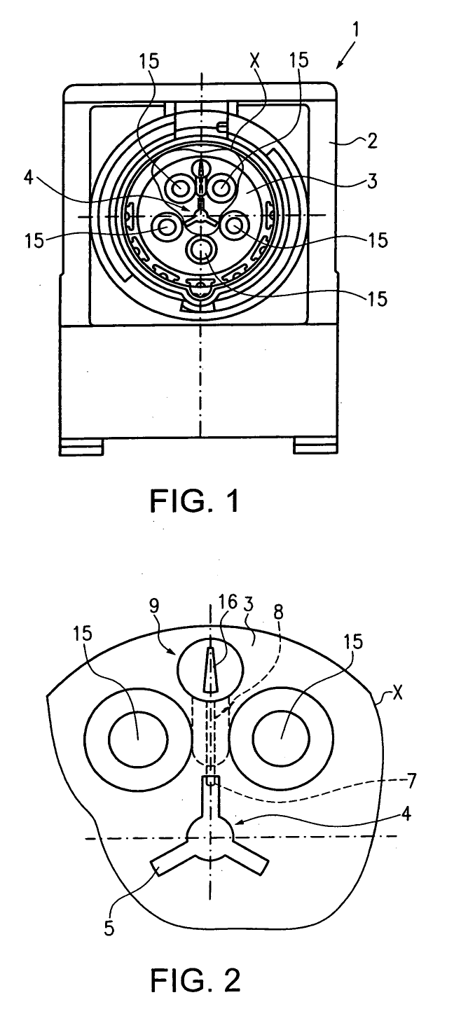

FIG. 1 shows a front view of a socket according to the present invention;

FIG. 2 shows an enlarged representation of a detail “X” of FIG. 1 in the inserted condition of the locking component,

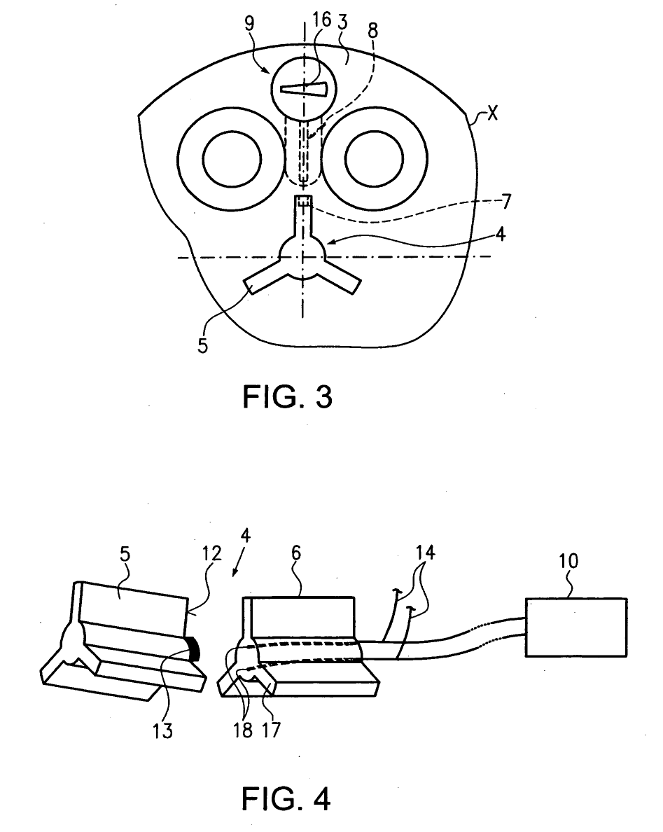

FIG. 3 shows a view analogously to FIG. 2 in the removed condition of the locking component, and

FIG. 4 shows a perspective top view of the locking component and of the blocking component in a simplified representation.

FIG. 1 shows a front view of an electrical socket 1 according to the present invention. This socket comprises a socket housing 2 having an approximately rectangular cross-section. In the upper part of the socket housing a socket insert 3 is supported such that it is rotatable between on- and off-positions of the socket. In the embodiment shown, five contact bushings 15 can be seen in the socket insert 3, respective contact pins of a plug, which is not shown, being adapted to be inserted into these contact bushings. A locking means 4 is arranged centrally between the contact bushings 15. This locking means is substantially pin-shaped and it is supported in a suitable hole in the socket insert such that it is displaceable between a blocking position and a release position. In the release position, the locking means 4 projects beyond the socket insert 3 and is, if at all, only partially pressed down into the socket insert, and in the blocking position the locking means 4 is pressed down into the socket insert 3 to such an extent that a rotary displacement of the socket insert is not possible. Only the release position of the locking means 4 allows the socket insert 3 to be rotated to its on-position by a suitable plug.

FIG. 2 shows an enlarged representation of a detail “X” of FIG. 1.

The locking means 4, cf. also FIG. 4, is implemented such that it consists of at least two parts, viz. the locking component 5 and the blocking component 6. When the electrical socket is intended to be used in explosion-proof areas, the locking component 5 is inserted and releasably secured in position in the socket insert 3. The releasable fastening is effected through engagement of a locking pin 8 with a lateral longitudinal slot 7 in the locking component 5. The locking pin 8 is displaceable by a closing cylinder 9 in the socket insert 3. In the position of engagement shown in FIG. 2, the locking component 5 is fastened in the socket insert 3 and supported such that it is displaceable in said socket insert 3.

The locking component 5 has a three-armed cross-section, the three arms being arranged at identical angles relative to one another. Other cross-sections are possible.

FIG. 3 shows a view analogously to FIG. 2. In said FIG. 3, the closing cylinder 9 has been rotated via a key (not shown) inserted in a keyhole 16, in such a way that the locking pin 8 is retracted from the longitudinal slot 7. This has the effect that the locking component 5 is released and that it can be removed from the socket insert 3. Below the locking component 5, a blocking component 6 is arranged, cf. also FIG. 4. For accommodating the locking component 5 and the blocking component 6 a suitably shaped hole is formed in the socket insert 3, the two components defining the locking means 4 being longitudinally guided in said hole.

FIG. 4 shows a perspective top view of the locking component 5 and of the blocking component 6. For the sake of simplicity, the socket insert 3 and other parts of the electrical socket 1 are not shown.

The locking component 5 and the blocking component 6 are two individual components of the pin-shaped locking means 4. Both have the same, essentially three-armed cross-section. The respective arms enclose identical angles.

A contact element 13 is arranged on an end 12 of the locking component 5 facing the blocking component 6. This contact element 13 can be implemented in the form of a substantially flat contact plate. When the locking component 5 and the blocking component 6 abut on one another, the contact element 13 serves as a short-circuit element interconnecting free ends 18 of electric lines 14. The free ends 18 of the electric line 14 are arranged in a front end 17 of the blocking component 6, said front end 17 facing the locking component 5. The electric lines 14 extend not only to the free ends 18 but also to an electric display means 10. On this display means 10 a warning, such as “do not use in explosion-prone areas”, can be displayed.

When the contact element 13 is not in contact with the free ends 18 in the removed condition of the locking component 5, the free ends 18 are, accordingly, not short-circuited and power is supplied to the display means 10 for displaying the warning. The electric display means 10 is only switched ineffective if the free ends 18 of the electric lines 14 are short-circuited.

1. An electrical socket (1), in particular for explosion-proof areas, comprising a socket insert (3), which is supported in a socket housing (2) such that it is adapted to be rotated between off- and on-positions and in which a substantially pin-shaped locking means (4) is supported such that it is displaceable between a pressed-down blocking position and a release position in which it projects beyond the socket insert (3), said socket insert (3) being rotatable between said off- and on-positions in the release position of the locking means (4),
characterized in that
the substantially pin-shaped locking means (4) is defined by at least one removable locking component (5) and a blocking component (6), which are arranged on top of one another in the socket insert (3), the locking component (5) projecting beyond the socket insert in the release position.

2. An electrical socket according to claim 1,
characterized in that
the locking component (5) and the blocking component (6) have identical cross-sections.

3. An electrical socket according to claim 1 or 2,
characterized in that
the locking component (5) is releasably secured in the socket insert (3).

4. An electrical socket according to one of the preceding claims,
characterized in that
the locking component (5) is provided with a lateral longitudinal slot (7) which is adapted to be engaged with a locking pin (8) that is displaceably supported in the socket insert (3).

5. An electrical socket according to one of the preceding claims,
characterized in that
the locking pin (8) is adapted to be displaced by a closing cylinder (9) arranged in the socket insert (3).

6. An electrical socket according to one of the preceding claims,
characterized in that,
in the removed condition of the locking component (5), a warning is visible.

7. An electrical socket according to one of the preceding claims,
characterized in that
the warning is visible on an electrically operated display means (10).

8. An electrical socket according to one of the preceding claims,
characterized in that,
when the locking component (5) and the blocking component (6) abut on one another, an electric contact (11) is closed and the electric display means is switched ineffective.

9. An electrical socket according to one of the preceding claims,
characterized in that
the locking component (5) has a contact element (13) on its end (12) facing the blocking component (6), said contact element (13) interconnecting electric lines (14) provided in or on the blocking component (6).
